(19) United States
(12) Patent Application Publication
(10) Pub. No.: US 2015/0128680 A1
(43) Pub. Date: May 14, 2015

(54) IMPACT TEST DEVICE AND IMPACT TEST METHOD FOR SIMULATING AN IMPACT

(71) Applicant: Airbus Operations GmbH, Hamburg (DE)

(72) Inventors: Andrej KLAAS, Hamburg (DE); Jens KRUEGER, Hamburg (DE); Sven DREWIN, Hamburg (DE)

(21) Appl. No.: 14/540,737

(22) Filed: Nov. 13, 2014

(30) Foreign Application Priority Data
Nov. 13, 2013 (DE) 10 2013 112 480.1

(51) Int. Cl. G01N 3/30

(52) U.S. Cl. CPC G01N 3/30
USPC 73/12.09

(57) ABSTRACT

Stated is an impact test device for simulating an impact of a body on a vehicle, which impact test device comprises a movable carriage and an actuator that is attached to the movable carriage. With the movable carriage at a standstill the actuator can move in a linear manner an impact body against the vehicle in order to deform the vehicle and to accelerate the movable carriage away from the vehicle. Since the mass of the actuator is significantly lighter than that of the movable carriage, termination of the impact test may take place very quickly.

### CROSS-REFERENCE TO RELATED APPLICATIONS

This application claims priority to German Patent Application No. 10 2013 112 480.1 filed Nov. 13, 2013, which is incorporated herein by reference in its entirety.

### TECHNICAL FIELD

The subject matter described herein relates generally to the field of impact testing. More particularly, the subject matter described herein, relates to (1) an impact test device for simulating an impact of a body on a vehicle, (2) to an impact test method for simulating an impact of a body on a vehicle, and (3) to a program element and to a computer-readable medium.

### BACKGROUND

In the context of structural tests relating to the construction of an aircraft having structural elements such as fuselage shells, longitudinal stiffening or transverse stiffening members and ribs, impact damage resulting from impact events is often inflicted on the structural elements in the context of structural tests. These tests are, in particular, useful when the primary structure of the aircraft or comprises carbon-fiber reinforced plastic (CFRP).

Carbon-fiber reinforced plastic structures may also be damaged by short impact events in which high forces are at work. In such cases, the damage may not be outwardly visible; however, such damaging events may significantly reduce the integrity of the carbon-fiber reinforced plastic components. For this reason it may be desirable to determine the tolerance of the structures with regard to impact damage that retrospectively is hard to detect.

In contrast to the wings and tail unit components of an aircraft, which are exposed to fast impact events such as bird strikes, the situation is different as far as the fuselage is concerned. That is the fuselage is exposed to the danger of being damaged by ground vehicles. These ground vehicles may comprise a mass of several tons up to 20 tons or more and move at relatively slow speed, for example, at 10 km/h. The energy released during an impact of such a ground vehicle on an aircraft fuselage may comprise several kilojoules.

Low-energy impact events, which convert energy of typically 1,000 joules, may be simulated with accelerated projectiles that impact the test body. Acceleration may occur as a result of the gravitational force of falling objects are used. As an alternative, it may also be possible to use springs, or pressurized gases, or explosives to accelerate an object. Typical masses of the projectiles may be between 0.5 kg and 50 kg. If heavy masses are to be accelerated, carriages may be considered that roll down a ramp before crashing against the structure to be tested. DE 10 2011 082 373 B4 and U.S. 020130061654 A describe methods and devices for reproducing an impact event to simulate a projectile.

U.S. 2012/0318039 A1 shows and describes an impact test device wherein a vehicle rolls down a ramp which accelerates the vehicle before impacting the structure to be tested. Once the carriage is in motion, terminating the impact test may difficult. Furthermore, if the impact of a heavy body weighing several tons is to be simulated, rapid test termination is not practical.

In addition, other objects, desirable features and characteristics will become apparent from the subsequent summary and detailed description, and the appended claims, taken in conjunction with the accompanying drawings and this background.

### SUMMARY

The term “simulating” means that an impact test device is designed for simulating an impact of a heavy vehicle (for example a ground vehicle) on the vehicle to be tested or on the structure to be tested. Furthermore, it the forces at work can be measured at any point during impact, and the impact test device can be designed to analyze and evaluate the impact event.

The impact test device comprises a movable carriage which has a mass of, for example, 5 tons. However, the carriage can be significantly heavier, for example 20 tons.

An actuator is provided that is attached to the movable carriage, body that is guided in a linear manner by the movable carriage. The shape of the impact body may replicate the shape of a region of the body on which the impact is to be simulated. For example, the impact body may replicate a rubber edge of a ground vehicle or a bumper.

The actuator may be designed with the movable carriage so as to move the impact body against the vehicle to deform the vehicle and to accelerate the movable carriage away from the vehicle.

The impact test device may thus be designed in such a manner that the very heavy movable carriage for simulating the impact of a ground vehicle or the like on the fuselage of an aircraft need not be moved onto the aircraft fuselage. Instead. the movable carriage is at first at a standstill, and only the significantly lighter actuator, which is attached to the movable carriage, engages, the fuselage. As a result of the forces experienced during impact, the movable carriage is then accelerated rearwards so that it moves away from the vehicle to be measured or tested.

It may thus be possible to simulate high-energy impact scenarios in that a movable carriage is used that at first is at a standstill. The carriage, however, has approximately the same mass as the ground vehicle to be simulated. Since the actuator together with the impact body that is guided in a linear manner may be much lighter in weight than the movable carriage, the impact body can be accelerated, and can also be stopped very quickly and precisely. In this manner the impact parameters, in particular the impact speed, can be set very precisely, and it is possible to control the impact process and to stop it at any point in time in order to prevent undesirable damage to the vehicle. In this manner, increased safety requirements may be met.

According to an embodiment, the actuator is in the form of a threaded spindle t a comprises an electric motor and a threaded rod, on one end of which the impact body is attached. Threaded advantageous in that they can transmit very considerable forces and may allow very precise movement of the impact body.

According to a further embodiment, the electric motor is attached to the movable carriage so that for moving the threaded rod may be arranged parallel to the longitudinal axis of the carriage. The motor thus propels the threaded rod together with the impact body forward in the direction of the vehicle.

According to a further embodiment, the impact test device comprises a control unit for setting the speed at which the impact body is moved relative to the carriage.

A sensor arrangement may be connected to the aforesaid control unit, which sensor arrangement monitors the impact event and if a particular predetermined event is detected terminates the impact test and movement of the impact body relative to the movable carriage is stopped.

According to a further embodiment, the actuator is designed for moving the impact body towards the vehicle at a constant speed of for example, 10 km/h relative to the movable carriage.

In accordance with a further embodiment, the movable carriage has a mass that is many times greater than the overall mass of the actuator and of the impact body. The mass ratio may be, for example, 50:1; however, other mass ratios may also be provided for.

According to a still further embodiment, an impact tea method for reproducing or simulating an impact of a body on a vehicle is provided and occurs, for example, on the fuselage of an aircraft. First an impact test device, which comprises a movable carriage with an impact body that is guided in a linear manner, is positioned relative to the vehicle. This is followed by movement, against the vehicle, of the impact body of the impact test device while the movable carriage is at a standstill, resulting in acceleration of the carriage away from the vehicle.

Since the device that moves the impact body in the direction of the vehicle is relatively light in weight, the impact speed may be set very precisely and quickly because there is no need to accelerate a large mass. For this reason, rapid termination of the impact test is possible.

According to yet a further embodiment, terminating the test method is accomplished by decelerating the impact body relative to the carriage, which may take place very quickly.

According to a yet another embodiment, a program element for controlling an impact test device, described above and below, for reproducing or simulating the impact of a body on a vehicle is proposed, which program element, when implemented on a processor of the impact test device, instructs the impact test device to move the impact body of the impact test device against the vehicle while the movable carriage is at a standstill. This results in acceleration of the carriage away from the vehicle.

Furthermore, the program element can be designed to implement the remaining steps described above and below. In this arrangement the program element can, for example, comprise software that is stored on a processor of the test device. The processor can also form part of the invention.

According to a further embodiment, a computer-readable medium is provided on which the program element described above and below is stored.

### BRIEF DESCRIPTION OF THE DRAWINGS

The various embodiments will hereinafter be described in conjunction with the following drawing figures, wherein like numerals denote like elements, and wherein:

FIG. 1 shows an impact test device according to an exemplary embodiment; and

FIG. 2 is a flow chart describing a method for conducting an impact test according to a further exemplary embodiment.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

The illustrations in the figures are diagrammatic and not to scale.

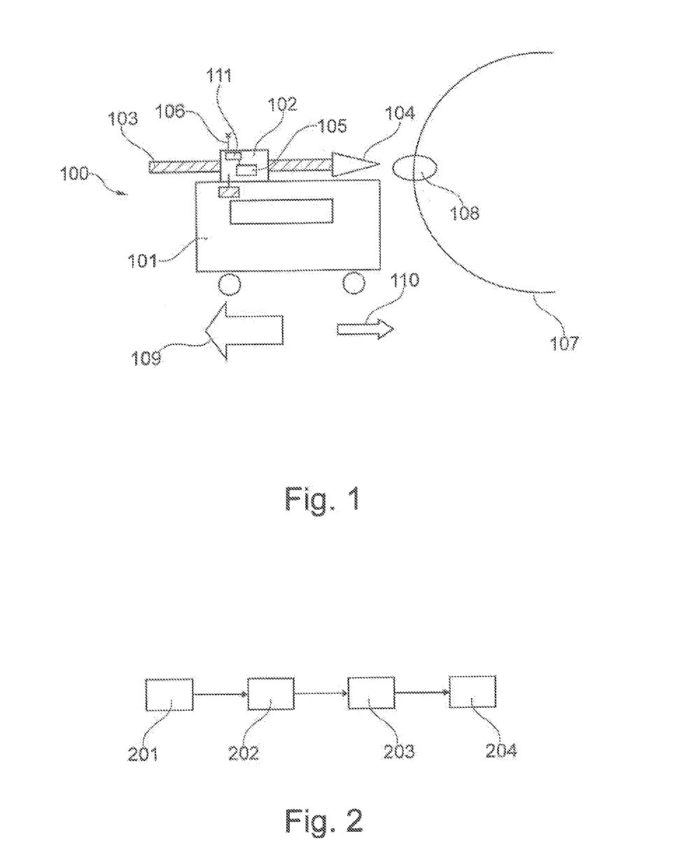

FIG. 1 illustrates an impact test device 100 for simulating an impact of a heavy body on a vehicle. The heavy vehicle can, for example, be a ground vehicle that impacts the fuselage of an aircraft. The impact test device 100 comprises a movable carriage 101 comprising a relatively heavy mass (between 1 and 20 tons, for example 5 tons). An actuator 102, 103, and 105 is attached to the movable carriage 101, as is an electric motor 105. The motor 105 is configured to move a threaded rod 103 relative to the movable carriage 101, For example, the actuator 102, 103, and 105 is designed in the form of a threaded-spindle device.

At the front end of the threaded rod 103 the impact body 104 is attached that is provided to impact the vehicle 107.

The vehicle 107 is, for example, a fuselage segment or a complete fuselage of an aircraft. The actuator 102, 103, and 105 may comprise a control unit 111 that controls, in particular, the movement of motor 105. This control unit 111 may comprise a wireless interface 106 for communicating with a central control computer in order to obtain control data and transmit the acquired sensor measuring data to the control computer. For example, the actuator may be designed to measure the forces that occur during impact on the impact body, as well as the speed at which the impact body is moved relative to the movable carriage 101.

At the beginning of the impact process, only the impact body 104 moves, driven forwards in a linear manner by the threaded spindle in the direction 110 of the vehicle 107; i.e. more precisely, onto impact surface 108.

During impact strong deformation forces can act that result in acceleration of the movable carriage 101 in the opposite direction 109.

If the impact test is to be interrupted quickly, the relative movement between the impact body 104 and the movable carriage 101 can be stopped, This is possible because the impact body and the threaded rod 103 arc relatively light in weight.

The movable carriage 101 can be modular in design so that its mass can easily and simply be increased or decreased in that additional modules may be added to or removed from the carriage.

The linear actuator 102, 103, and 105 is, for example, arranged on the top of the movable carriage 101 or on one of its lateral surfaces and is firmly coupled to the movable carriage so that only the threaded spindle 103 and the impact body can be moved relative to the movable carriage. Such actuators are, for example, used in milling machines in Which positional changes need to be set with considerable force.

The threaded spindle 103 does not contact the movable carriage 101. The impact body 104 is coupled to have a shape that matches the part of the body whose impact is to be simulated, which body would actually impact the vehicle if an accident were to occur. This is, for example, the bumper of a ground vehicle or a rubber edge. It is not only the shape of this part of the body that is reproduced, but also its characteristics in terms of elasticity, rigidity, breaking resistance, etc.

At commencement of the test the movable carriage 101 is moved into position in front of the vehicle 107, and thereafter the impact body 104 is moved by the actuator 102, 103, and 105 in the direction of the vehicle. As the impact body impacts the vehicle, it continues to move forwards in the direction of the arrow 110, at first, for example, without changing its speed. This results in deformation of the region 108 of the vehicle 107. The deformation forces acting in this process result in acceleration of the movable carriage 101 rearward in the direction of the arrow 109, so that the speed of the impact body relative to the vehicle 107 is reduced, as would also be the case in a real accident. Since the heavy movable carriage 101 then moves away from the vehicle 107 there is no danger of the carriage damaging the vehicle 107.

It should be pointed out that the control unit 111 can comprise a storage element (computer-readable medium) on which the program element described above is stored.

FIG. 2 illustrates a flow chart of an impact method according to an exemplary embodiment. In step 201 an impact test device is positioned relative to a vehicle. The test device comprises a movable carriage with an impact body that is guided in a linear manner. In step 202, with the movable carriage at a standstill, the impact body of the impact test device is accelerated towards the vehicle and is then moved towards the vehicle at a predetermined speed profile. In step 203 the impact body impacts the vehicle, which results in deformation of a region of the vehicle, and also in acceleration of the heavy movable carriage away from the vehicle. In step 204 the test method is stopped such that movement of the impact body relative to the carriage is decelerated, stopped or even reversed. The impact body then moves in the opposite direction relative to the carriage.

It should be pointed out that characteristics or steps which have been described with reference to one of the above exemplary embodiments can also be used in combination with other characteristics or steps of other exemplary embodiments described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1. An impact test device for simulating an impact of a body on a vehicle, comprising:
a movable carriage;
an actuator coupled to the movable carriage; and
an impact body coupled to the actuator that is guided in a substantially linear manner by the actuator;
wherein the actuator is designed with the movable carriage at a standstill to move the impact body against the vehicle in order to deform the vehicle and to accelerate the movable carriage away from the vehicle.

2. The impact test device of claim 1,
wherein the actuator is a threaded spindle, comprising:
an electric motor; and
a threaded rod, on one end of which the impact body is attached.

3. The impact test device of claim 2, wherein the electric motor is coupled to the movable carriage and arranged parallel to the longitudinal axis for moving the threaded rod.

4. The impact test device of claim 1, further comprising:
a control unit for setting the speed at which the impact body is moved relative to the movable carriage.

5. The impact test device of claim 1,
wherein the actuator is designed for moving the impact body towards the vehicle at a constant speed of substantially 10 km/h relative to the movable carriage.

6. The impact test device of claim 1,
wherein the movable carriage has a mass that is substantially greater than the combined mass of the actuator and of the impact body.

7. An impact test method for simulating an impact of a body on a vehicle, with the method comprising the steps of:
positioning, relative to the vehicle, an impact test device that comprises a movable carriage coupled to an impact body for guiding the impact body in a linear manner;
moving the impact body of the impact test device against the vehicle while the movable carriage is at a standstill, resulting in acceleration of the movable carriage away from the vehicle.

8. The impact test method of claim 7, further comprising stopping the test by decelerating the movement of the impact body relative to the movable carriage.

9. A program product stored on a computer readable medium, wherein the program product if configured to execute the method of claim 1 when implemented on a processor of the impact test device.

10. (canceled)

11. An impact test device, comprising;
a movable carriage;
an impact body;
a threaded spindle coupled to the impact body for guiding the impact body in a substantially linear manner to impact and deform the vehicle and accelerate the movable carriage away from the vehicle.

12. The impact test device of claim 11 wherein the threaded spindle comprises:
an electric motor;
and a threaded rod, on one end of which the impact body is attached.

13. The impact test device of claim 12 further comprising a control unit for setting the speed at which the impact body is moved relative to the movable carriage.
